(19) United States
(12) Patent Application Publication
(10) Pub. No.: US 2011/0258786 A1
(43) Pub. Date: Oct. 27, 2011

(54) Selectively movable assembly and a method for allowing ingress and egress to and from a portion of a selectively movable vehicle

(76) Inventor: John Micheli, Dearborn, MI (US)

(21) Appl. No.: 12/799,475

(22) Filed: Apr. 27, 2010

(51) Int. Cl. B65G 69/30

(52) U.S. Cl. 14/71.1

(57) ABSTRACT

A movement assembly 40 for use in combination with a selectively movable assembly 10 and which includes ramps 88, 90 which are carried by the assembly 10 without appreciably decreasing the amount of storage space provided by the assembly and which may be selectively deployed to allow for efficient ingress into and egress from the assembly 10.

### GENERAL BACKGROUND

1. Field of the Invention

The present invention generally relates to a selectively movable assembly and to a method for allowing ingress and egress to and from a portion of a selectively movable assembly and, more particularly, to a selectively movable assembly having a portion which selectively and efficiently allows for the movement of people and/or items into and out of a bed.

2. Background of the Invention

A selectively movable assembly, such as by way of example and without limitation, a vehicle or a truck, a ship, a train, or an aircraft is used to selectively carry or transport people and/or items to various locations. For example and without limitation, a truck typically has a bed or storage portion upon which these items and/or people reside until the desired location is reached and then the items are unloaded from the bed or storage portion and/or the people depart from the bed or storage portion.

While prior selectively movable assemblies do allow items and/or people to be selectively placed or enter into the bed or storage compartment and then be removed or leave the bed or storage compartment, they do so in a rather inefficient manner. That is, typically the bed or storage compartment (it should be appreciated the following use of the word “bed’ denotes both a storage bed which is generally flat as well as a storage compartment or portion which may not be flat and thus this term “bed” should broadly be construed to refer to any portion of a selectively movable assembly upon which items/good and/or people may selectively and removably reside) is positioned at a certain distance above the ground upon which the selectively movable assembly is moved. Ingress into and egress from the bed is thus difficult to achieve (e.g., people must jump onto and off of the bed, thereby risking injury and heavy and bulky items must be physically lifted onto and off of the bed, thereby making the loading and unloading the bed very inefficient and increasing the likelihood of injury to workers).

One strategy which has been utilized has been the use of steps or ramps which are brought into close proximity to or in an abutment relationship to the selectively movable assembly and which increases the efficiency of such desired bed ingress and egress. However, the distance that beds of various selectively movable assemblies resided above the relevant ground vary and thus steps and ramps may not be useful in many cases (e.g., they may be too short to reach a particular bed). Moreover, selectively movable assemblies are deployed in a wide variety of environments, such is in a desert battlefield in which it is imperative that the troops, residing upon the bed, be allowed to quickly depart from the bed. Inefficient egress from the bed will increase the likelihood of death or injury to these troops. It is also imperative that troops which are to be “loaded onto” the selectively movable assembly be allowed to quickly and efficiently enter the bed. Jumping onto or out of the bed is not only inefficient but given the weight and amount of material carried by a soldier, such “jumping” will greatly increase the likelihood of bodily injury to these soldiers. Ramps and/or steps are simply not available in a “war zone” or battlefield, and may not be available in other non-war environments. Carrying steps or ramps has not been considered a good alternative because of the need to maximize storage space in the bed.

There is therefore a need for a new and improved selectively movable assembly which allows for selective and efficient ingress and egress in and out of the bed and for a method for allowing efficient ingress and egress in and to the bed of a selectively movable vehicle and which overcomes the various and previously delineated disadvantages of prior and current strategies, techniques, and assemblies.

### SUMMARY OF THE INVENTIONS

It is a first non-limiting object of the present inventions to provide a selectively movable assembly which overcomes some or all of the previously delineated disadvantages of prior assemblies.

It is a second non-limiting object of the present inventions to provide a method of allowing efficient ingress and egress in and to a selectively movable assembly and which overcomes some or all of the previously delineated disadvantages of prior techniques, strategies, and methods.

It is a third non-limiting object of the present invention to allow selective and efficient ingress and egress into and out of a bed of a selectively movable assembly without adversely effecting the storage space of the bed.

According to a first non-limiting aspect of the present invention, a selectively movable assembly is provided and includes a bed portion; at least one platform portion which is selectively and removably disposed upon the bed portion and which includes a longitudinal slot; and at least one ramp which is selectively and removably disposed upon the bed portion and which resides within the longitudinal slot of the platform portion.

According to a second non-limiting aspect of the present invention, a selectively movable assembly is provided and includes a bed; a first platform portion which is longitudinally coextensive to the bed and which covers one half of the bed; a second platform portion which is longitudinally coextensive to the bed and which covers a second half of the bed and which abuts the first platform portion, wherein each of the first and second platform portions cooperate with the bed to respectively form first and second slotted cavities; a first ramp which is selectively and movably disposed within the first slotted cavity; a second ramp which is selectively and movably disposed within the second slotted cavity and wherein each of the first and the second ramps are substantially identical and wherein each of the first and second ramps are selectively movable from a first respective slot occupying position to a second extended position in which the first and second ramps each allow egress and ingress out of and into the bed and wherein each of the first and second ramps are independently and selectively movable to the respective second extended position and to the respective first slot occupying position.

According to a third non-limiting aspect of the present invention, a method for allowing ingress and egress into and from a bed of a selectively movable assembly is provided and includes the steps of providing at least one ramp; providing at least one platform, the platform being the same length as the base; placing the ramp upon the base; placing the platform upon the ramp; moving the ramp away from the platform while allowing the platform to remain upon the base; and attaching the platform to the selectively movable assembly effective to allow ingress and egress into and from the bed to occur over the ramp.

These and other features, aspects, and advantages of the various present inventions will become apparent from a reading of the following detailed description of the preferred embodiments of the inventions, including the subjoined claims and by reference to the following drawings.

### BRIEF DESCRIPTION OF THE DRAWINGS

FIG. 1 is a perspective view of a selectively movable assembly which is made in accordance with the teachings of the preferred embodiment of the invention.

FIG. 2 is a perspective and partially unassembled view of the selectively movable assembly which is shown in FIG. 1.

FIG. 3 is another perspective and partially unassembled view of a selectively movable assembly which is shown in FIG. 1.

FIG. 4 is a perspective and partially cut-away view of the selectively movable assembly which is shown in FIG. 1.

FIG. 5 is an exploded view of the sectional area denoted by reference number “5” in FIG. 4.

FIG. 6 is an exploded view of the sectional area denoted by reference number “6” in FIG. 4.

FIG. 7 is a perspective view of the selectively movable assembly which is shown in FIG. 1 and further showing the movement assembly which is selectively moved to an outwardly extended position.

FIG. 8 is an exploded view of the sectional area denoted by reference numeral “8” in FIG. 7.

FIG. 9 is a perspective view of a selectively movable assembly which is made in accordance with a second embodiment of the invention.

FIG. 10 is a perspective view of the selectively movable assembly which is shown in FIG. 1 and further shown without a movement assembly.

FIG. 11 is a perspective view of a ramp portion which is made in accordance with the teachings of the preferred embodiment of the invention.

FIG. 12 is a side view of a platform portion which is shown in FIG. 3 and taken in the direction of view arrow “11”.

FIG. 13 is a top view of the platform portion which is shown in FIG. 11.

FIG. 14 is a front view of the movement assembly which is shown in FIG. 1 and taken in the direction of view arrow “13”.

FIG. 15 is a bottom view of the ramp portion which is shown in FIG. 10.

FIG. 16 is an exploded view of the sectional area denoted by reference numeral “16” in FIG. 1 and shown in a first position.

FIG. 17 is an exploded view of the sectional area denoted by reference numeral “16” in FIG. 1 and shown in a second position.

### DETAILED DESCRIPTION OF THE PREFERRED EMBODIMENT OF THE INVENTION

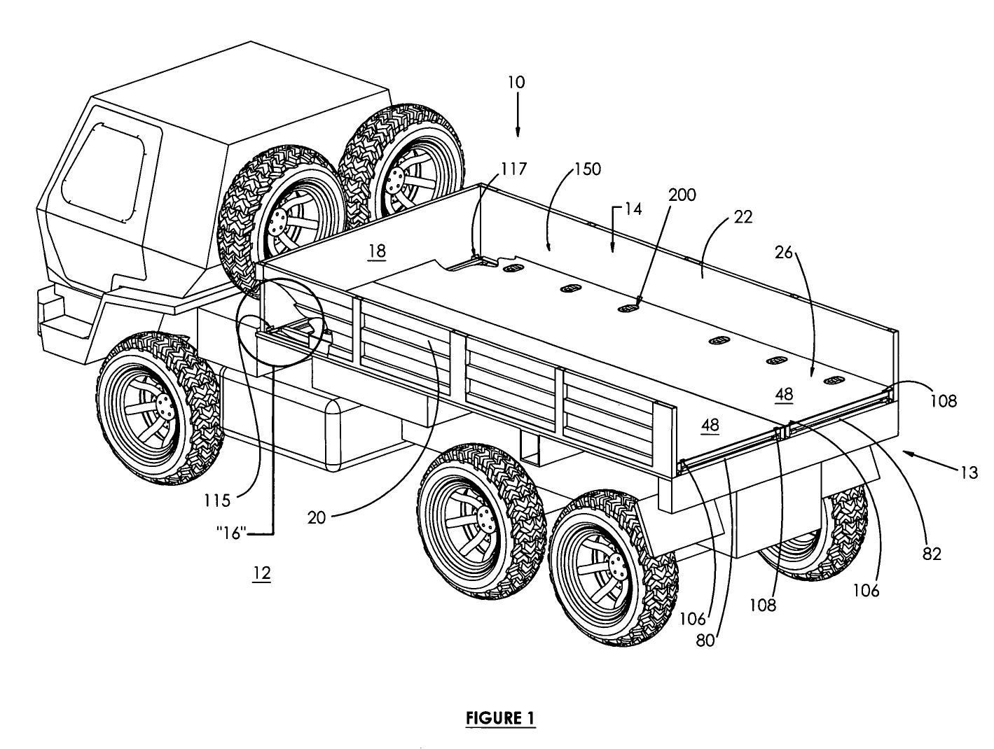

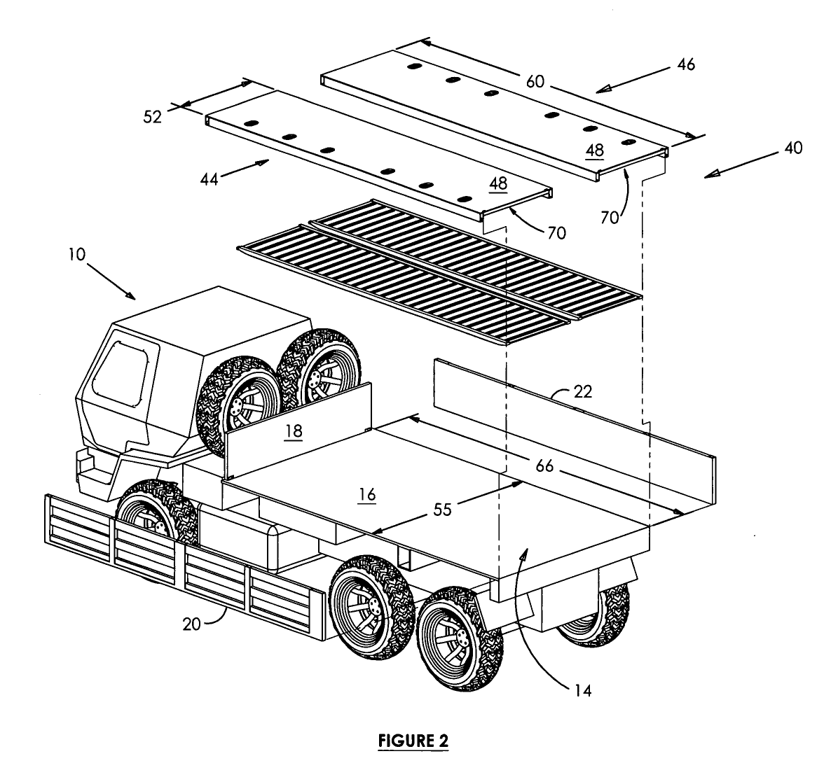

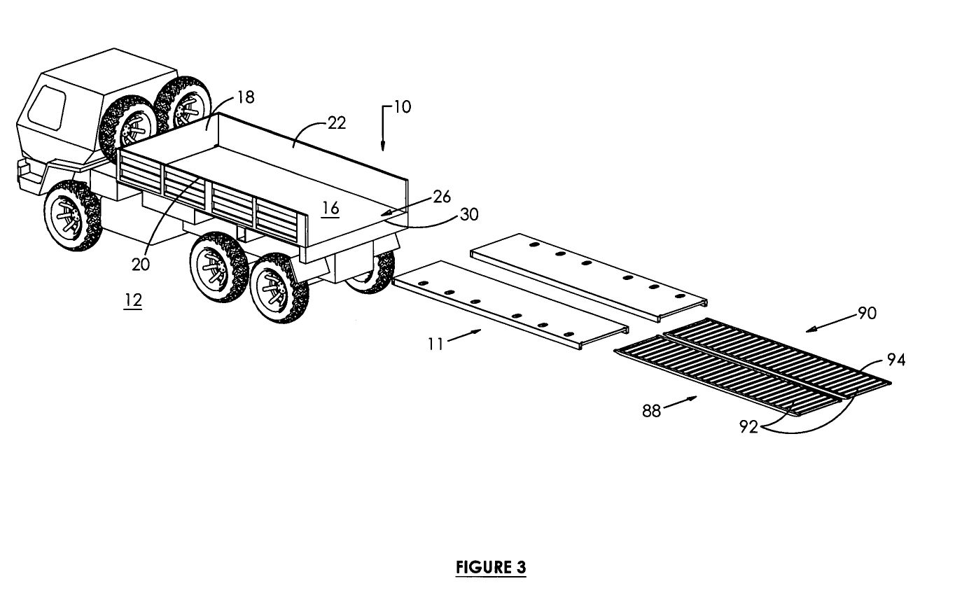

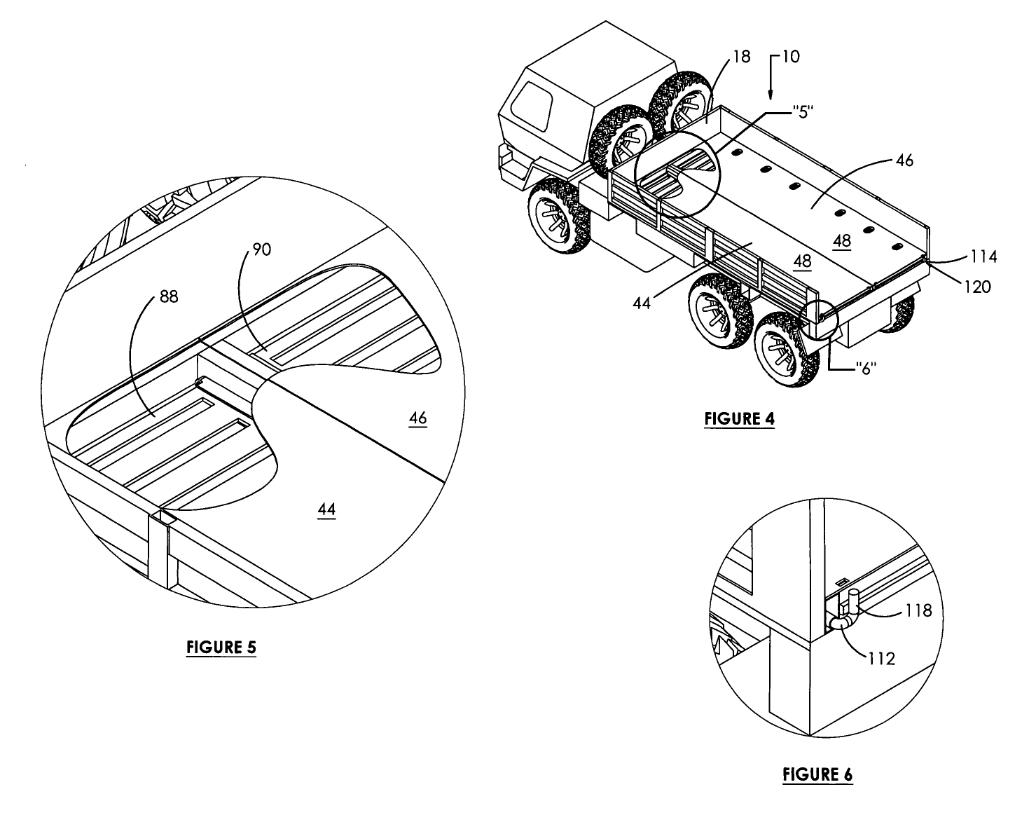

Referring now to FIGS. 1, 2, 4, 6, and 7, there is shown a selectively movable assembly 10 which is made in accordance with the teachings of the preferred embodiment of the invention. It should be appreciated that while assembly 10 comprises a truck or personnel carrier, that the various present inventions may be applicable to a wide variety of selectively movable assemblies, and that nothing in this description is meant to limit the various present inventions to a particular type of selectively movable assembly. Any assembly which is selectively movable may include each of the various inventions which are described, more fully, below.

Assembly 10 may be selectively movable or navigatable upon the ground 12 and includes a bed or storage portion 14 upon which items/material and/or people (i.e., soldiers), may be selectively placed. Efficient ingress into and egress from the bed 14 is very important for each of the reasons which have been previously and more fully delineated.

The bed 14 includes a generally flat floor 16 which orthogonally and integrally terminates into sides 18, 20, and 22 and the sides 18-22 cooperate with the floor 16 to cooperatively form a storage compartment with an open end 26 through which ingress into and egress from the cooperatively formed storage compartment may be achieved. The open end 26 may be selectively closed or opened by use of a tail gate (not shown) which may be movably affixed to the frame edge 30 of the assembly 10.

A movement assembly 40 may be provided, according to the teachings of the various inventions, to efficiently allow such desired ingress into and egress from the bed 14. Particularly, the movement assembly 40 includes a pair of substantially identical platforms 44, 46 which are generally rectangular and which each have a respective flat face 48. In one non-limiting embodiment of the invention, the respective width 52 of each platform 44, 46 is about one half of the width 55 of the bed 14, and the respective length 60 of each platform 44, 46 is about the same as the length 66 of the bed 14. When the platforms 44, 46 are operatively disposed upon the bed 14, the respective flat faces 48 are positioned remote from the flat floor 16.

Further, each platform 44, 46 includes a respective longitudinal trench 70 which has a generally “C” shaped cross sectional area and which communicated with the floor 16 and the trenches 70 are substantially identical and longitudinally coextensive to the sides 20, 22. The respective trenches 70 of platforms 44, 46 cooperate with the floor 16 to respectively form respective storage areas 80, 82.

The movement assembly 40 further includes a pair of substantially identical ramps 88, 90 and each ramp 88, 90 is generally rectangular and is of the same size and shape as each of the trenches 70. Each ramp 88, 90 includes a respective ridged surface 92 having a plurality of ridges 94 and a pair of opposed and substantially identical projections or hooks 99, 100 which emanate from respective end 102. Each platform 44, 46 at respective end 104 has two opposed and substantially identical holes 106, 108.

As is shown perhaps best in FIG. 1, each ramp 88, 90 is adapted to be selectively and removably and storably inserted into and made to reside within unique trenches 70. In this manner, the respective flat faces 48 may provide support (in place of floor 16) for the items and/or people that are to reside within the bed 14. The ramps 88. 90 are stored and hidden from the occupants of the bed 14. Due to the open top 112 of the bed 14, the movement assembly 40 does not reduce the storage capacity of the bed 14. Rather, the movement assembly 40 fits beneath a raised floor defined by the platform 44, 46.

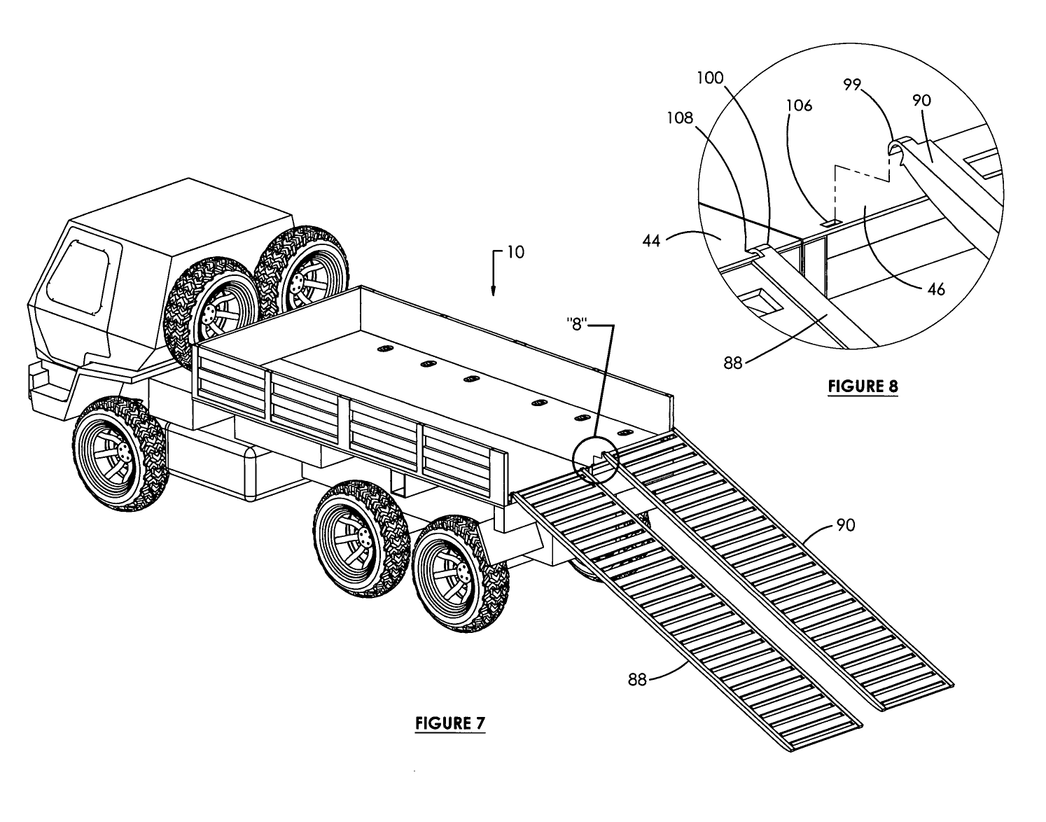

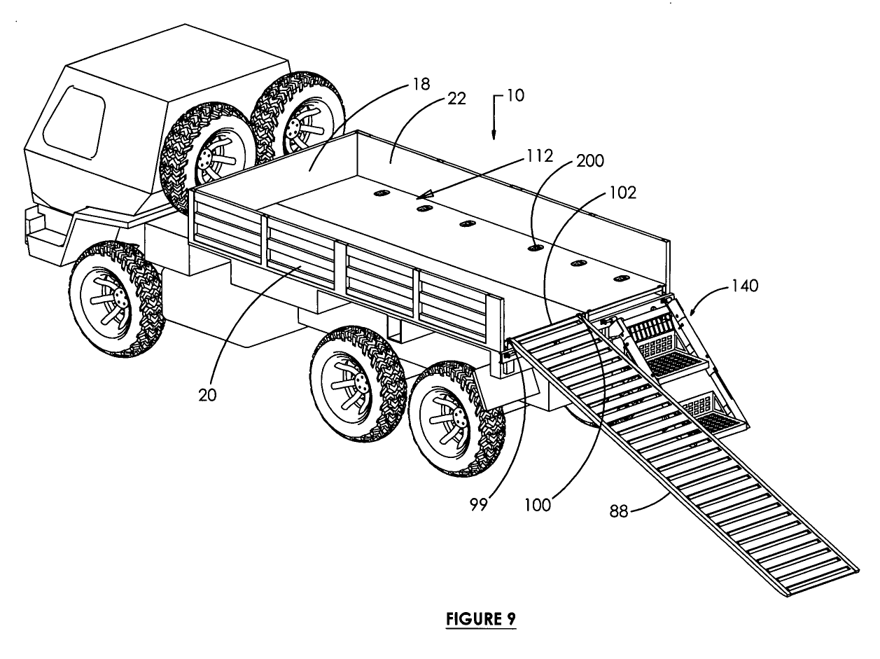

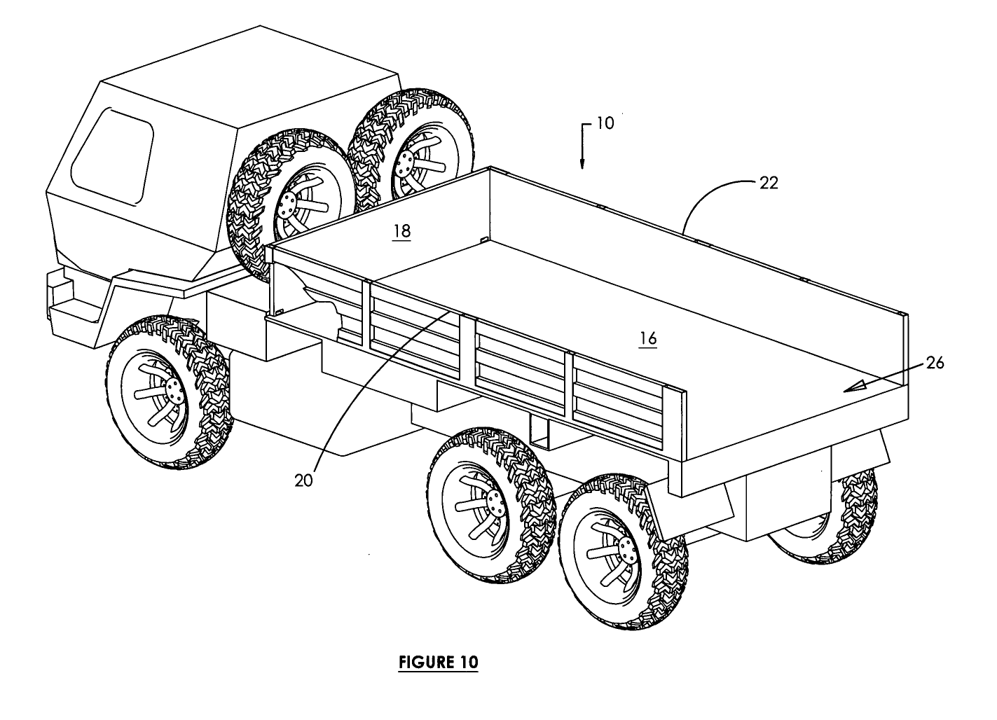

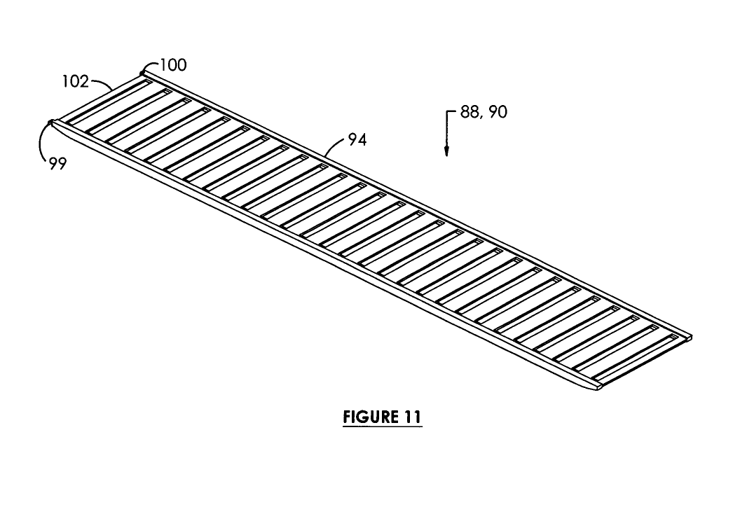

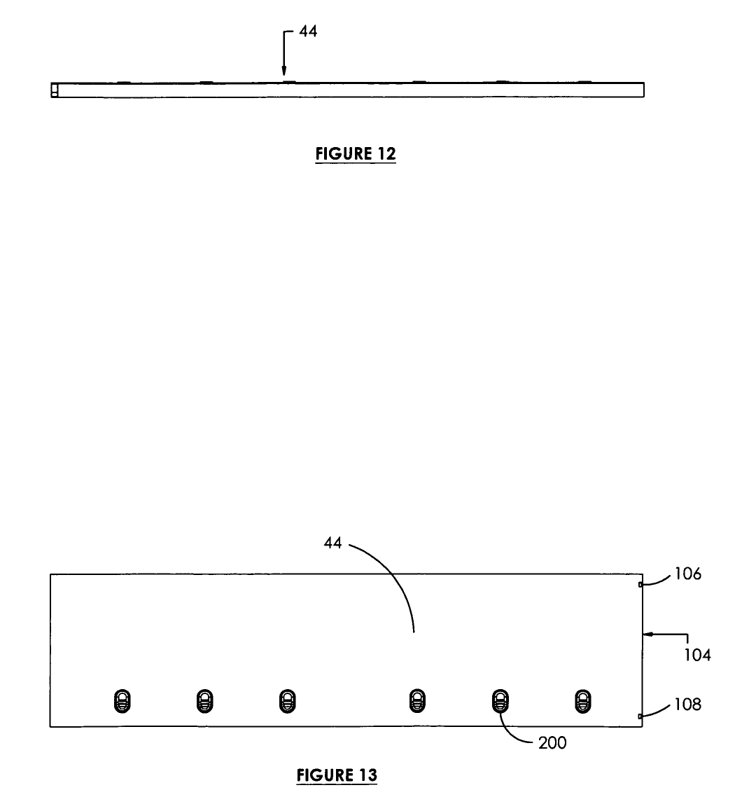

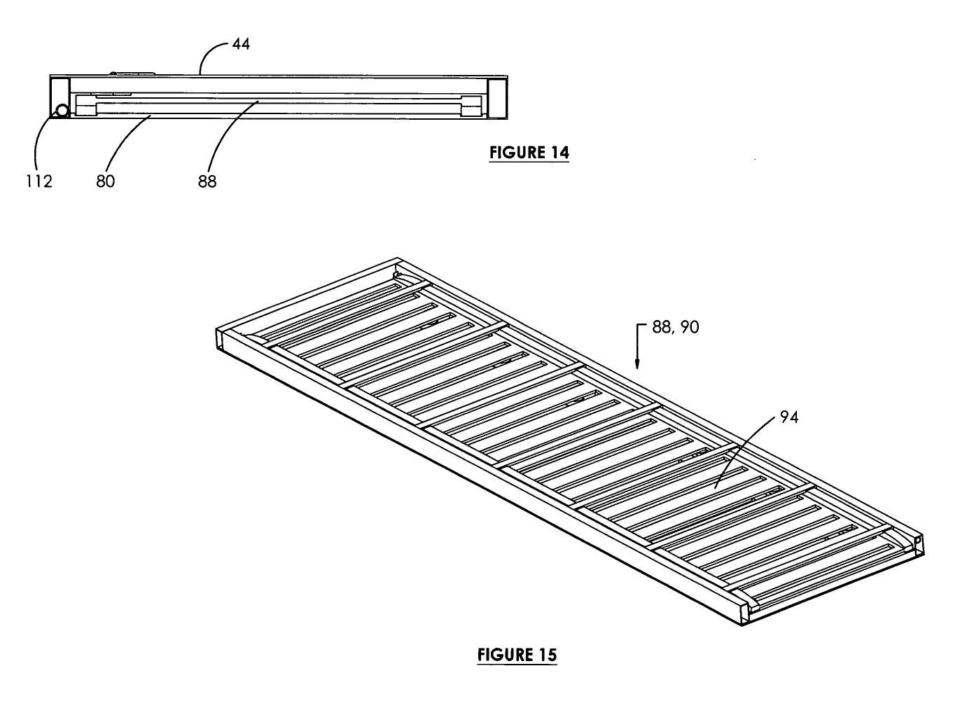

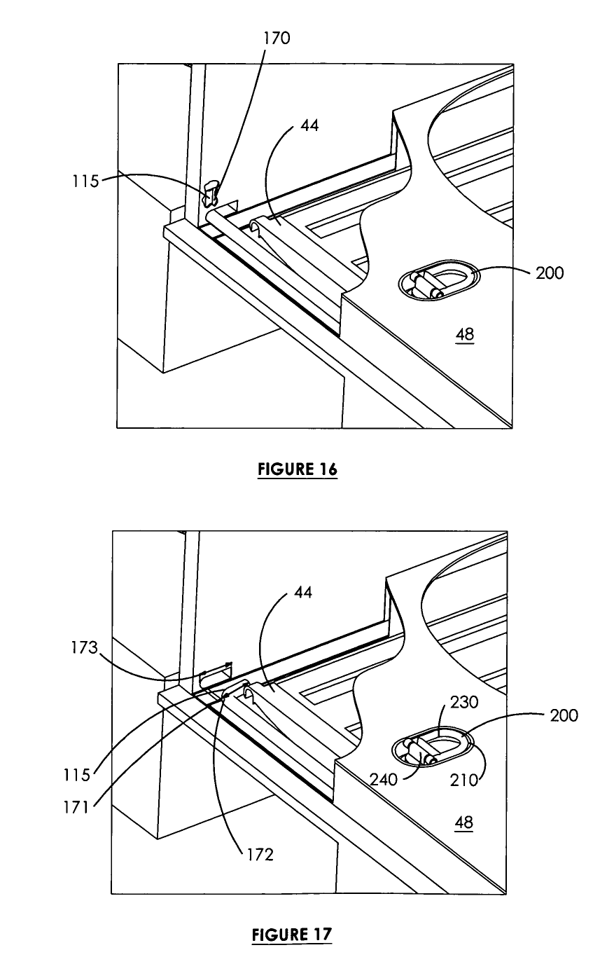

When ingress into or egress out of the bed 14 is desired, one or both of the ramps 88, 90 are removed from the respective trench 70 that the ramps 88, 90 are residing within. Protrusions 99, 100 of a first of the ramps 88 are selectively and removably and respectively inserted into holes 106, 108 of the platform 44, while protrusions 99, 100 of a second of the ramps 90 are selectively and removably and respectively inserted into the holes 106, 108 of the platform 46 (see, for example, FIGS. 7 and 8).

After the desired ingress and egress is accomplished, the ramps 88, 90 are “unhooked” from respective platforms 44, 46 and respectively inserted into the trenches 70 respectively formed within the platforms 44, 46. People and/or material may be made to quickly and efficiently traverse the ramps 88, 90.

In a non-limiting embodiment of the various inventions, first and second substantially identical rods 112, 114 may be fixedly but rotatably coupled to side member 18 (e.g., each rod 112, 114 respectively resides within a ball assembly (not shown) which is movably embedded the member 18). Alternatively, each rod 112, 114 may have a respective “L” shaped end 115 which fits into a respective slot 170 formed within member 18. The respective ends 115 may respectively rotate behind/within the side member 18, but cannot come out of the slot 170 because the respective length 171 of each respective curved portion 172 of each end 115 is longer than the length 173 of each substantially identical slot 170. Each rod 112, 114 also has a respective hooked end 118, 120. The first hooked end 118 may be moved from a first position in which the end 118 does not contact ramp 88 to a second ramp 88 contacting position. In the first position, the end 118 allows the ramp 88 to be removed from trench 70 of the platform 44, while in the second position, the ramp 88 may not be removed from the trench 70 of the platform 44. Similarly, the second hooked end 120 may be moved from a first position in which the ramp 90 may be removed from the trench 70 of the platform 46, to a second position in which the ramp 90 may not be removed from the trench 70 of the platform 46. The respective movement of ends 118, 120 is facilitated by the movements of respective ends 115 within/behind side member 18.

In yet another non-limiting embodiment of the invention, other types of stairs, such as stair assembly 140 shown in FIG. 8, may be used and selectively and removably attached to the movable assembly 10 alongside or in close proximity to ramp 88 or ramp 90. In this manner, various and dissimilar types of stair assemblies or ingress/egress assemblies may be used in combination with the ramps 88, 90. Moreover, since the ramps 88, 90 are carried by the assembly 10 they are always available to those operating/residing within the assembly 10, independent of the environment that the assembly 10 operates within the ramps 88, 90 (and all other portions of the movement assembly 40) may be constructed from composite materials or from plastic, metal, and/or wood type materials and each ramp 88. 90 are respectively and independently movable to a respective and operative extended or stored position. The term “independent” means each ramp 88, 90 may be moved without movement of the other ramps 88, 90. In a non-limiting embodiment, each face 48 maybe smooth or may respectively includes a plurality of tie downs 200 which are used to selectively receive a hook, rope, or other member/material to selectively secure items upon the respective faces 48. Each tie down 200 respectively and movably resides within a unique slot 210 formed in one of the faces 48 and is movable from a respective first stored position (shown in FIG. 17) to a selective extended position in which the hook portion 230 is or orthogonal to the face 48. Such movement is facilitated to the coupling of the hook portions 230 to a pin 240 residing with the slot 210.

It is to be understood that the various present inventions are not limited by the exact construction or methodology which has been described above, but that various changes and modifications may be made without departing from the spirit and the scope of the inventions as they may be delineated in the following claims. Thus, it should be appreciated that substantially any truck having a floor or bed may utilize the assembly 40 and thus may have formed a storage space in which to put one or more ramps. Therefore movement assembly 40 may be directed to the truck aftermarket so that the assembly 40 can be operatively utilized in trucks/vehicles not having or not provided with a ramp/loading assembly. Alternatively, each platform 44, 46 may respectively be coupled to either bed 16 and/or one or more of the sidewalls 18, 20, 22 by the use of a bolt/screw or other fastener each respective corner of the respective platforms 44, 46.

Also, it should be appreciated that the ramps 88, 90 may each be of a “multi-piece” design in which they may each comprise several ramps which are coupled in a longitudinal or “end to end” manner. Each platform 44, 46, may also be compromised of several panels which are coupled together to form respective panel 44, 46. Further, each ramp 88, 90 can be used in many other ways, such as a bridge or a ladder to scale buildings or in any other manner desired.

What is claimed is:

1) A selectively movable assembly comprising a bed portion; at least one platform portion which is selectively and removably disposed upon said bed portion and which includes a longitudinal slot; and at least one ramp which is selectively and removably disposed upon said bed portion and which resides within said longitudinal slot of said platform portion.

2) The selectively movable assembly of claim 1 wherein said platform portion comprises a pair of substantially identical platforms.

3) The selectively movable assembly of claim 2 wherein each of said substantially identical platforms are made of metal.

4) The selectively movable assembly of claim 2 wherein each of said substantially identical platforms are made of plastic.

5) The selectively movable assembly of claim 2 wherein each of said substantially identical platforms are made of a composite material.

6) A selectively movable assembly comprising a bed; a first platform portion which is longitudinally coextensive to said bed and which covers one half of said bed; a second platform portion which is longitudinally coextensive to said bed and which covers a second half of said bed and which abuts said first platform portion, wherein each of said first and second platform portions cooperate with said bed to respectively form first and second slotted cavities; a first ramp which is selectively and movably disposed within said first slotted cavity; a second ramp which is selectively and movably disposed within said second slotted cavity and wherein each of said first and said second ramps are substantially identical and wherein each of said first and second ramps are selectively movable from a first respective slot occupying position to a second extended position in which said first and second ramps each allow egress and ingress out of and into said bed and wherein each of said first and second ramps are independently and selectively movable to said respective second extended position and to said respective first slot occupying position.

7) The selectively movable assembly of claim 6 wherein said first and second ramps are substantially identical.

8) The selectively movable assembly of claim 7 wherein each of said first and second ramps respectively include a plurality of ridges.

9) The selectively movable assembly of claim 8 wherein each of said platforms respectively include a pair of holes and wherein each of said ramps respectively includes a pair of hooks and wherein said pair of hooks of a first of said ramps selectively and respectively reside within said pair of holes within a first of said ramps and wherein said pair of hooks of said second of said ramps selectively and respectively reside within said pair of holes within a second of said ramps.

10) The selectively movable assembly of claim 9 further including at least one selectively movable rod which is movable from a first ramp contacting position in which said at least one selectively movable rod prevents movement of said first ramp to an extended position and wherein said at least one selectively movable rod is also moveable to a second position in which said first ramp is allowed to move to an extended position.

11) A method for allowing ingress and egress into and from a bed of a selectively movable assembly comprising the steps of providing at least one ramp; providing at least one platform, said platform being the same length as said base; placing said ramp upon said base; placing said platform upon said ramp; moving said ramp away from said platform while allowing said platform to remain upon said base; and attaching said platform to said selectively movable assembly effective to allow ingress and egress into and from said bed to occur over said ramp.
